(19) United States
(12) Patent Application Publication
(10) Pub. No.: US 2019/0086032 A1
(43) Pub. Date: Mar. 21, 2019

(54) GAS FILLING METHOD

(71) Applicant: HONDA MOTOR CO., LTD., Tokyo (JP)

(72) Inventor: Kiyoshi HANDA, Saitama (JP)

(21) Appl. No.: 16/085,222

(22) PCT Filed: Feb. 27, 2017
(86) PCT No.: PCT/JP2017/007476

§ 371 Date: Sep. 14, 2018

(30) Foreign Application Priority Data
Mar. 15, 2016 (JP) 2016-051261
Jun. 10, 2016 (JP) 2016-115848

(51) Int. Cl. F17C 5/06; F17C 13/02

(52) U.S. Cl. CPC F17C 5/06; F17C 13/025; F17C 2223/036; F17C 2225/0123; F17C 2250/043; F17C 2223/0123

(57) ABSTRACT

A gas filling method is divided into an initial step and a main step, and can finish the main step even if a small-volume tank is connected. A gas filling step is divided into an initial step and a main step whereby a predetermined target rising-pressure rate is realized. The method can include estimating initial pressure P₀ of the tank when starting the initial step and an initial rising-pressure rate ΔP₀ of a hydrogen tank for the initial step, and calculating a reference rising-pressure rate ΔP_{BS} of the hydrogen tank where the pressure of the hydrogen tank is initial pressure P₀ as a reference point. The main step is started from the reference point without executing the initial step a target rising-pressure rate ΔP_{ST} is set for the main step using a deviation between the initial rising-pressure rate ΔP₀ and the reference rising-pressure rate ΔP_{BS}.

### BACKGROUND OF THE INVENTION

### Field of the Invention

The present invention relates to a gas filling method. In more detail, it relates to a gas filling method of a moving body that connects a supply source of compressed gas and a tank equipped to the moving body, and fills the gas into the tank of the moving body.

### Related Art

Fuel cell vehicles travel by supplying oxygenated air and hydrogen gas, which is the fuel gas, to the fuel cell, and driving an electric motor using the electric power thereby generated. In recent years, progress has been made in the practical implementation of fuel cell vehicles employing such fuel cells as the energy source for generating motive power. Although hydrogen gas is required to generate electric power by fuel cells, with the fuel cell vehicles of recent years, vehicles have become mainstream that store a sufficient amount of hydrogen gas in advance in a high-pressure tank or a hydrogen tank equipped with a storage alloy, and use the hydrogen gas inside of the tank to travel. In addition, in concert with this, research relating to filling technology for quickly filling as large an amount of hydrogen gas as possible into a tank is also actively advancing (for example, refer to Patent Document 1).

FIG. 8 is a graph showing an example of the change in pressure inside the hydrogen tank during the filling of hydrogen gas. As shown in FIG. 8, the gas filling step from initiating the filling of hydrogen gas at time t0 until completing at time t5 is divided into the two steps of the initial filling step at first, and subsequently the main filling step.

Initial filling step is a step of filling hydrogen gas provisionally in order to acquire information related to the tank necessitated for performing the subsequent main filling step. As shown in FIG. 8, in this initial filling step, pre-shot filling (time t0˜t1) for measuring the initial pressure of the tank, volume detection filling (time t2˜t3 for measuring the volume of the tank, etc. are included. In addition, main filling step is a step of filling hydrogen gas until becoming completely filled under flowrate control using the information of the tank obtained in the initial filling step, the temperature of outside air at this time, etc.

Herein, although the temperature of the tank rises when filling hydrogen gas into the tank, this temperature rise has a great influence on the pressure rise velocity, i.e. rising-pressure rate, of the tank during filling of hydrogen gas. For this reason, in the main filling step, it is often the case that a target rising-pressure rate is decided, and the flowrate of hydrogen gas supplied to the tank is controlled so that this target rising-pressure rate is realized.

If the target rising-pressure rate is higher than an appropriate rising-pressure rate, although hydrogen gas will be more quickly filled in proportion thereto, the temperature of the tank will increase prior to arriving at complete filling, and the necessity to interrupt or stop filling itself may arise. In addition, if the target rising-pressure rate is lower than the appropriate rising-pressure rate, although it is possible to curb the temperature rise of the tank in proportion thereto, the time required until arriving at complete filling will extend, and thus convenience worsens. For this reason, it is necessary to set the target rising-pressure rate to the appropriate magnitude in order to quickly and appropriately perform the main filling step. In addition, such an appropriate rising-pressure rate can be calculated using a known algorithm so long as using a reference point specified according to the start time of filling and initial pressure of the tank at the start time, volume of the tank, outside air temperature, temperature of hydrogen gas, etc. FIG. 8 shows the change in tank pressure in the case of filling hydrogen gas under the appropriate rising-pressure rate obtained with time t0 and the initial pressure P0 as the reference point, by the dotted line A-B.

Patent Document 1: PCT International Publication No. WO2011/058782

### SUMMARY OF THE INVENTION

However, the gas filling step of the gas filling methods proposed in recent years mostly is divided in the initial filling step and main filling step as mentioned above. In this case, since a certain amount of hydrogen gas is filled under an unknown rising-pressure rate in the initial filling step prior to starting the main filling step, the pressure and temperature inside the tank thereby also rise. Therefore, in order to set the target rising-pressure rate in the main filling step to an appropriate magnitude, it is necessary to grasp the change in the state of the tank from the filling start time until the completion time of the initial filling step and the state of the tank at the moment of completion of the initial filling step by performing the initial filling step, and to set the target rising-pressure rate with the state of the tank at the moment of completion of this initial filling step as the reference point.

However, upon setting the target rising-pressure rate in the main filling step, the conventional gas filling methods are not considering the change in the state of the tank due to the existence of the initial filling step, i.e. by executing the initial filling step. In other words, with the conventional gas filling methods, the rising-pressure rate (slope of dotted line A-D in FIG. 8) obtained with the start time of the initial filling step as a reference point has been set as the target rising-pressure rate in the main filling step (slope of solid line C-D in FIG. 8). For this reason, with the conventional gas filling methods, the pressure of the tank will rapidly rise in proportion as filling hydrogen gas at a rising-pressure rate higher than the rising-pressure rate serving as the reference in the initial filling step. In other words, the overall rising-pressure rate arrived at by summing the initial filling step and main filling step (slope of line A-D in FIG. 8) becomes larger than the appropriate rising-pressure rate decided by a known algorithm (slope of line A-B in FIG. 8), and rises to the same pressure at time t5, which is earlier than the completion time t6 in the case of filling under the appropriate rising-pressure rate. For this reason, with the conventional gas filling methods, the temperature rise of the tank becomes large, and the necessity for interrupting or stopping filling prior to reaching complete filling may arise.

It should be noted that, if the tank that is the filling target is one equipped to a general, four-wheeled fuel cell vehicle, since the pressure rise amount from the initial filling step will be sufficiently small relative to the pressure rise amount from the main filling step, the deviation between the overall rising-pressure rate and appropriate rising-pressure rate will also be small. However, since the pressure rise amount from the initial filling step increases more compared to the pressure rise amount from the main filling step with smaller volumes of the tank that is the filling target, the deviation between the overall rising-pressure rate and the appropriate rising-pressure rate also increases, and the above-mentioned such problem becomes more pronounced.

The present invention has an object of providing a gas filling method for filling gas that is divided into an initial filling step and a main filling step, and can appropriately finish the main filling step, even if a tank of small volume is connected.

According to a first aspect, a gas filling method for connecting a supply source (e.g., the pressure accumulator 91 described later) of compressed gas with a tank (e.g., the hydrogen tank 31 described later) equipped to a moving body (e.g., the vehicle V described later) by way of piping (e.g., the station piping 93 and vehicle piping 39 described later), and filling gas into the tank, includes: a gas filling step from after initiating until completing filling of gas which is divided into an initial filling step (e.g., Steps S1˜S7 in FIG. 5, or Steps S21˜28 in FIG. 7 described later) of filling gas in order to obtain information related to the tank; and a main filling step (e.g., Steps S8˜S12 in FIG. 5, or Step S29 in FIG. 7 described later) of filling gas so that a target rising-pressure rate decided using the information obtained while executing the initial filling step is realized. The gas filling method includes: an initial rising-pressure rate estimation step (e.g., Steps S4˜S5 of FIG. 5, or Steps S25˜S26 in FIG. 7 described later) of estimating an initial pressure (e.g., the initial pressure P₀ described later) of the tank during start of the initial filling step and an initial rising-pressure rate (e.g., the initial rising-pressure rate ΔP₀ described later) of the tank in the initial filling step; a reference rising-pressure rate calculation step (e.g., the reference rising-pressure rate ΔP_{BS} described later) of calculating a reference rising-pressure rate of the tank in a case with a state in which the pressure of the tank is the initial pressure as a reference point, and assuming to start the main filling step from the reference point without executing the initial filling step; and a target rising-pressure rate setting step (e.g., Step S7 in FIG. 5, or Step S28 in FIG. 7 described later) of setting the target rising-pressure rate for the main filling step using a deviation between the initial rising-pressure rate and the reference rising-pressure rate.

According to a second aspect, in this case, it is preferable for the target rising-pressure rate to be set to lower than the reference rising-pressure rate in the target rising-pressure rate setting step, in a case of the initial rising-pressure rate being higher than the reference rising-pressure rate.

According to a third aspect, in this case, it is preferable for an on-off valve (e.g., the flowrate control valve 94b described later), and a pressure sensor (e.g., the first station pressure sensor 97c described later) for detecting pressure on an upstream side from the on-off valve to be provided in the piping; in the initial filling step, after raising the pressure within a predetermined storage segment (e.g., the segment in the station piping 93 from the flowrate control valve 94b to the shut-off valve 94a described later) in the piping on an upstream side from the on-off valve in a state closing the on-off valve, the on-off valve to be opened, and pre-shot filling (e.g., Step S1 in FIG. 5, or Step S21 in FIG. 7 described later) to be performed to fill compressed gas within the storage segment into the tank; and the initial pressure and the initial rising-pressure rate to be estimated in the initial rising-pressure rate estimation step, based on the pressure within the piping detected using the pressure sensor after executing the pre-shot filling, the volume of the storage segment, and the volume of the tank.

According to a fourth aspect, in this case, it is preferable for the initial pressure to be estimated based on the pressure within the piping detected using the pressure sensor after executing the pre-shot filling, the volume of the storage segment, and the volume of the tank, and the initial rising-pressure rate to be estimated based on the pressure within the piping detected using the pressure sensor after executing the pre-shot filling, and a time required in the pre-shot filling, in the initial rising-pressure rate estimation step.

According to a fifth aspect, in this case, it is preferable for the gas filling method to further include a volume estimation step (e.g., Step S9 in FIG. 5, or Step S24 in FIG. 7 described later) of acquiring an amount of gas filled into the tank during a predetermined time period under a fixed rising-pressure rate, and estimating the volume of the tank using the amount of gas acquired.

According to a sixth aspect, in this case, it is preferable for the volume of the tank to be acquired using communication between the supply source and the moving body, and the initial pressure and the initial rising-pressure rate to be estimated using the volume (e.g., the volume transmitted value V_{IR} described later) thus acquired, in the initial rising-pressure rate estimation step; the initial rising-pressure rate estimation step, the reference rising-pressure rate calculation step and the target rising-pressure rate setting step to be executed up until starting the main filling step; and the volume estimation step to estimate the volume of the tank using a time period immediately after starting the main filling step under the target rising-pressure rate set in the target rising-pressure rate setting step.

According to a seventh aspect, in this case, it is preferable to further include: a tank volume verification step (e.g., Step S10 in FIG. 5 described later) of comparing between the volume of the tank acquired using communication in order to estimate the initial pressure and the initial rising-pressure rate in the initial rising-pressure rate estimation step, and the volume of the tank estimated in the volume estimation step.

According to an eighth aspect, in this case, it is preferable in a case of relative error in the difference between the volume acquired using the communication and the volume estimated in the volume estimation step being at least a predetermined value in the tank volume verification step, for the target rising-pressure rate set in the target rising-pressure rate setting step to be corrected, and the main filling step to be continued using a corrected target rising-pressure rate.

According to a ninth aspect, in this case, it is preferable for a volume of the tank to be estimated in the volume estimation step using a time period for which gas is filled at a fixed rising-pressure rate determined in advance in the initial filling step; and the initial pressure and the initial rising-pressure rate to be estimated in the initial rising-pressure rate estimation step using the volume of the tank estimated in the volume estimation step.

According to a tenth aspect, in this case, it is preferable for the target rising-pressure rate to be set in the target rising-pressure rate setting step so that a completion predicted time of the main filling step becomes the same time as a completion predicted time (e.g., the completion predicted time t_{end} in FIG. 6 described later) of the main filling step in a case of executing the main filling step under the reference rising-pressure rate from the reference point without executing the initial filling step.

In the first aspect of the present invention, gas is filled into the tank of a moving body from the supply source by dividing into the initial filling step and main filling step. In the initial rising-pressure rate estimation step, the initial pressure of the tank when starting the initial filling step and the initial rising-pressure rate of the tank in the initial filling step are estimated, and further, a reference rising-pressure rate is calculated using the estimated initial pressure of the tank in the reference rising-pressure rate calculation step. More specifically, the rising-pressure rate in the case with a state in which the pressure of the tank is the initial pressure estimated in the initial rising-pressure rate estimation step as a reference point, and assuming to start the main filling step from the reference point without executing the initial filling step, is calculated as the reference rising-pressure rate. Then, in the target rising-pressure rate setting step, the target rising-pressure rate for the main filling step is set using the deviation between the initial rising-pressure rate estimated in the initial rising-pressure rate estimation step and the reference rising-pressure rate calculated in the reference rising-pressure rate calculation step. Herein, when adopting the reference rising-pressure rate as the target rising-pressure rate for the main filling step as is, in the case of the initial rising-pressure rate being higher than the reference rising-pressure rate, the temperature rise of the tank becomes larger than assumed under the reference rising-pressure rate as explained by referencing FIG. 8, and the tank may reach an excessive temperature rise, and thus there is concern over no longer being able to appropriately finish the main filling step. In contrast, the present invention estimates the initial rising-pressure rate which has not been grasped conventionally, and in the case of the initial rising-pressure rate being higher than the reference rising-pressure rate due to setting the target rising-pressure rate using the deviation between this and the reference rising-pressure rate, can make the target rising-pressure rate lower than the reference rising-pressure rate in order to correct for this deviation; therefore, it is possible to suppress so as to make the temperature rise of the tank in the main filling step approach that assumed under the reference rising-pressure rate. Consequently, according to the present invention, even in a case of a small-volume tank being connected, it is possible to prevent an excessive temperature rise of the tank, and finish the main filling step appropriately.

The second aspect of the present invention makes the target rising-pressure rate lower than the reference rising-pressure rate in the case of the initial rising-pressure rate being higher than the reference rising-pressure rate. In other words, the present invention can prevent an excessive temperature rise of the tank and thus finish the main filling step appropriately, even in a case of a small-volume tank being connected, by falling back the target rising-pressure rate for the main filling step to the reference rising-pressure rate using the initial rising-pressure rate, which has not been grasped conventionally.

According to the third aspect, in the initial filling step, after raising the pressure inside a storage segment on an upstream side from the on-off valve in a state closing the on-off valve, which is provided in the piping, the on-off valve is opened, and compressed gas inside the storage segment is swiftly filled into the tank. In addition, in the initial rising-pressure rate estimation step, after equalizing the pressure from the piping to the tank by executing the pre-shot filling as described above, the pressure inside of the piping is detected using the pressure sensor provided in the piping, and the initial pressure and the initial rising-pressure rate are estimated using this pressure, the volume of the storage segment and the volume of the tank. Since it is thereby possible to precisely estimate the initial pressure and initial rising-pressure rate, the target rising-pressure rate set using these can be set to an appropriate magnitude.

According to the fourth embodiment, in the initial rising-pressure rate estimation step, the initial pressure is estimated based on the pressure within the piping detected using the pressure sensor after equilibrating the pressure from the piping until the tank by executing the pre-shot filling as mentioned above, the volume of the storage segment and the volume of the tank. In addition, the initial rising-pressure rate is further estimated based on the initial pressure obtained in this way, the pressure within the piping after executing the pre-shot filling, and the time required in the pre-shot filling. Since it is thereby possible to precisely estimate the initial pressure and initial rising-pressure rate, the target rising-pressure rate set using these can be set to an appropriate magnitude.

According to the fifth aspect, in the volume estimation step, the amount of gas filled into the tank during a predetermined time period under a fixed rising-pressure rate is acquired, and the volume of the tank is estimated using this. In the case of estimating the initial pressure and initial rising-pressure rate as mentioned above, information related to the volume of the tank is necessary. Consequently, by estimating the volume of the tank according to the volume estimation step, the present invention can estimate the initial pressure, initial rising-pressure rate, etc. using this. It should be noted that the information related to the volume of the tank can be grasped during the initial filling step on the supply source side using communication established between the moving body and the supply source during filling. In such a case, the result of estimating in the volume estimation step can be used in order to verify the credibility of the result acquired using communication.

According to the sixth aspect, the volume of the tank is acquired using communication, and the initial pressure and initial rising-pressure rate are estimated using this in the initial rising-pressure rate estimation step. In addition, this initial rising-pressure rate estimation step, the reference rising-pressure rate calculation step using the results obtained in this step and the target rising-pressure rate setting step are executed until starting the main filling step. Then, the main filling step is started under the target rising-pressure rate set in the target rising-pressure rate setting step, and the volume of the tank is estimated in the above-mentioned volume estimation step using the time period immediately after starting this main filling step. In other words, since it is possible to start the main filling step promptly without waiting for the results of the volume estimation step by executing the main filling step and volume estimation step concurrently, the present invention can prevent the filling time from lengthening.

According to the seventh aspect of the present invention, the target rising-pressure rate is provisionally set using the volume of the tank obtained by communication, and after starting the main filling step under this target rising-pressure rate, the volume of the tank is estimated by a separate route from communication by executing the volume estimation step concurrently with this main filling step. Then, in the tank volume verification step, the volume of the tank obtained by communication used in order to provisionally set the target rising-pressure rate, and the volume of the tank estimated by executing the volume estimation step are compared. It is thereby possible to verify the credibility of the information related to the volume of the tank obtained by communication, while promptly initiating the main filling step.

According to the eighth aspect of the present invention, in a case of the relative error in the difference between the volume acquired using the communication and the volume estimated in the volume estimation step being at least a predetermined value in the tank volume verification step, the target rising-pressure rate for the main filling step in execution is corrected, and the main filling step is continued using the corrected rate. It is thereby possible to continue filling while preventing excessive temperature rise of the tank, even in a case of the volume acquired using communication in order to set the original target rising-pressure rate being erroneous.

According to the ninth aspect of the present invention, the volume of the tank is estimated using the time period of filling gas at a fixed rising-pressure rate during the initial filling step, and the initial pressure and initial rising-pressure rate are estimated using this. The initial pressure and initial rising-pressure rate are thereby estimated even in a case of not being able to acquire the volume of the tank using communication, and thus it is possible to set the target rising-pressure rate for the main filling step using these subsequently.

According to the tenth aspect of the present invention, the target rising-pressure rate is set so that the completion predicted time of the main filling step becomes a completion predicted time of the main filling step in a case with a state in which the pressure of the tank is the initial pressure as a reference point, and assuming to execute the initial filling step under the reference rising-pressure rate. Since the target rising-pressure rate is thereby set so as to be lower than the reference rising-pressure rate, even in a case of the initial rising-pressure rate being higher than the reference rising-pressure rate, it is possible to prevent an excessive temperature rise of the tank, and finish the main filling step appropriately, even in case of a small-volume tank being connected.

### BRIEF DESCRIPTION OF THE DRAWINGS

FIG. 1 is a view showing the configuration of a hydrogen filling system to which a hydrogen gas filling method according to a first embodiment of the present invention is applied;

FIG. 2 is a functional block diagram showing the configuration of a control circuit for filling flowrate control;

FIG. 3 is a view showing a specific algorithm for setting a target pressure increase rate;

FIG. 4 is a view illustrating a sequence for setting a target pressure increase rate;

FIG. 5 is a flowchart showing a sequence for filling hydrogen gas in the hydrogen filling system;

FIG. 6 is a time chart made to schematically show the flow of filling of hydrogen gas realized by the flowchart of FIG. 5;

FIG. 7 is a flowchart showing a sequence for filling hydrogen gas in the hydrogen filling system according to a second embodiment; and

FIG. 8 is a view showing an example of the change in pressure inside of a hydrogen tank during the filling of hydrogen gas.

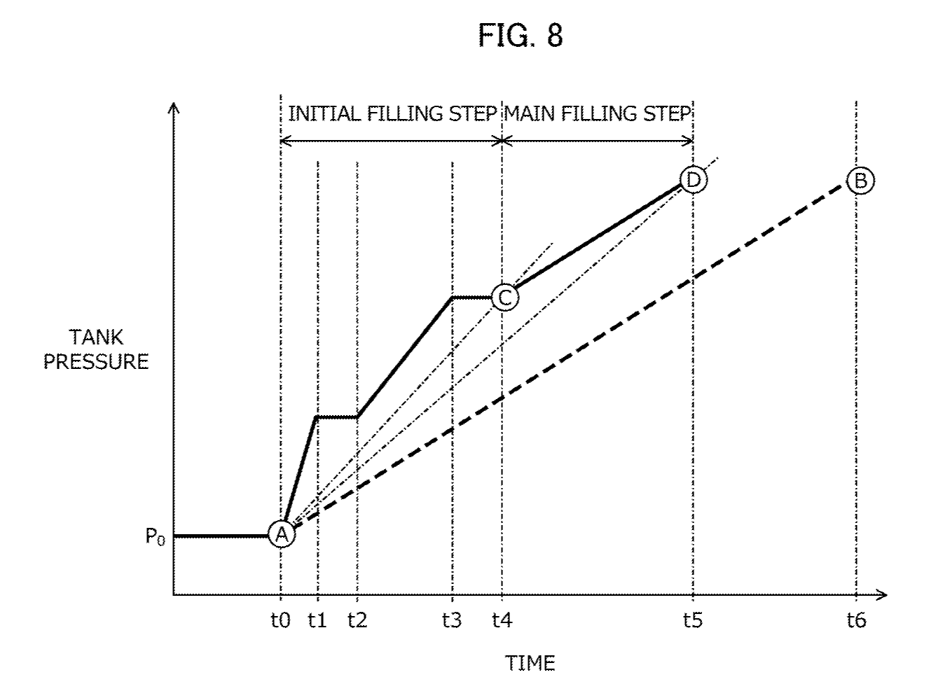

### DETAILED DESCRIPTION OF THE INVENTION

### First Embodiment

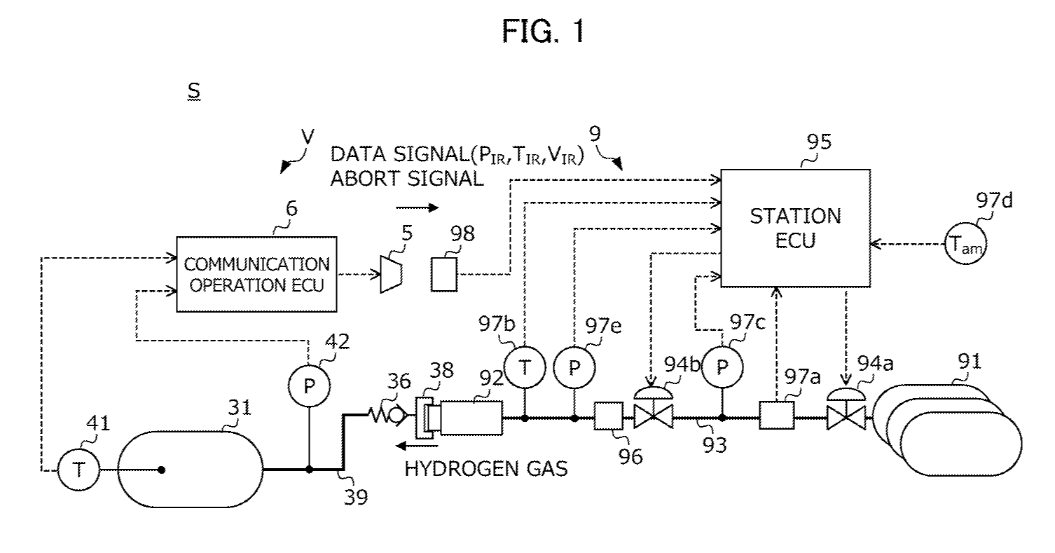

Hereinafter, a first embodiment of the present invention will be explained while referencing the drawings. FIG. 1 is a view showing the configuration of a hydrogen filling system S to which a hydrogen gas filling method according to the present embodiment is applied. The hydrogen filling system S is configured by combining a fuel cell vehicle V that travels with hydrogen gas as fuel gas, and a hydrogen station 9 that supplies hydrogen gas to a hydrogen tank of this vehicle V. Hereinafter, the configuration on a side of the vehicle V will be explained first, and then the configuration on the side of the station 9 will be explained.

The vehicle V includes a hydrogen tank 31 that stores hydrogen gas supplied from the station 9, a vehicle piping 39 that extends from this hydrogen tank 31, a fuel cell system (not illustrated) that generates electricity from the hydrogen gas stored in the hydrogen tank 31 and uses the generated electric power to travel, an infrared communicator 5 that sends data signals related to the hydrogen tank 31 to the hydrogen station 9, and a communication operation ECU 6 that generates data signals to send from this infrared communicator 5.

The vehicle piping 39 includes a receptacle 38 into which a filler nozzle 92 described later of the hydrogen station 9 fits, and a check valve 36 that is provided in the vehicle piping 39 near the receptacle 38 and is for preventing hydrogen gas from flowing backwards from the hydrogen tank 31 side to the receptacle 38.

As means for acquiring information related to the aforementioned hydrogen tank 31, an in-tank temperature sensor and an in-tank pressure sensor 42 are connected to the communication operation ECU 6. The in-tank temperature sensor detects the temperature of hydrogen gas inside of the hydrogen tank 31, and sends a signal corresponding to the detection value to the communication operation ECU 6. The in-tank pressure sensor 42 detects the pressure inside of the hydrogen tank 31, and sends a signal corresponding to the detection value to the communication operation ECU 6.

The communication operation ECU 6 is a microcomputer configured by an interface that A/D converts the detection signals of the above-mentioned sensors 41, 42, a CPU that executes signal generation processing described later, a driving circuit that drives the infrared communicator 5 in a determined state under the above-mentioned processing, a storage device that stores various data, etc.

Programs related to execution of the data signal generation processing described later, and characteristic information containing the volume value of the hydrogen tank equipped at the time at which the vehicle V was manufactured, are recorded in a storage device of the communication operation ECU 6. It should be noted that, other than volume value of the hydrogen tank, for example, information related to the hydrogen tank 31 that can be specified at the time of manufacture such as the capacity derived by a known conversion law from the volume value, and the material of the hydrogen tank, is included in this characteristic information.

The CPU of the communication operation ECU 6 starts signal generation processing to generate a signal to be sent from the communicator 5 to the hydrogen station 9, with the event of a fuel lid protecting the receptacle 38 being opened, for example. In addition, the CPU of the communication operation ECU 6 ends the signal generation processing, with the event of entering a state in which filling of hydrogen gas becomes impossible, such as a case of detecting that the above-mentioned nozzle has been removed from the receptacle 38, or a case of detecting that the fuel lid has been shut, for example.

In the signal generation processing, a temperature transmitted value T_{IR} corresponding to the current value of the temperature in the hydrogen tank, a pressure transmitted value P_{IR} corresponding to the current value of pressure in the hydrogen tank, and a volume transmitted value V_{IR} corresponding to the current value of the volume of the hydrogen tank are acquired every predetermined period, and a data signal according to these values (T_{IR}, P_{IR}, V_{IR}) is generated. For the temperature transmitted value T_{IR}, the detection value of the in-tank temperature sensor 41 at this time is used. For the pressure transmitted value P_{IR}, the detection value of the in-tank pressure sensor 42 at this time is used. In addition, for the volume transmitted value V_{IR}, a value recorded in the aforementioned storage device is used.

In addition, in the signal generation processing, the temperature transmitted value T_{IR} and pressure transmitted value P_{IR} acquired periodically as mentioned above and abort thresholds decided in advance for each transmitted value are compared, and in the case of either of these transmitted values exceeding the abort threshold during filling, an abort signal for requesting ending of filling to the hydrogen station 9 is generated.

The drive circuit of the communication operation ECU 6 causes the infrared communicator 5 to be driven (flash) according to the data signals and abort signal generated by the above-mentioned signal generation processing. Data signals including state information related to the state inside the hydrogen tank (i.e. temperature transmitted value T_{IR}, pressure transmitted value P_{IR}, etc.) as well as characteristic information (i.e. volume transmitted value V_{IR}, etc.) and abort signals are thereby sent to the hydrogen station 9.

The hydrogen station 9 includes a pressure accumulator in which hydrogen gas for supplying to the vehicle V is stored at high pressure; station piping 93 that reaches the filler nozzle 92 for discharging hydrogen gas from the pressure accumulator 91, a shut-off valve 94a and flowrate control valve 94b provided in the station piping 93, and a station ECU 95 that controls these valves 94a, 94b.

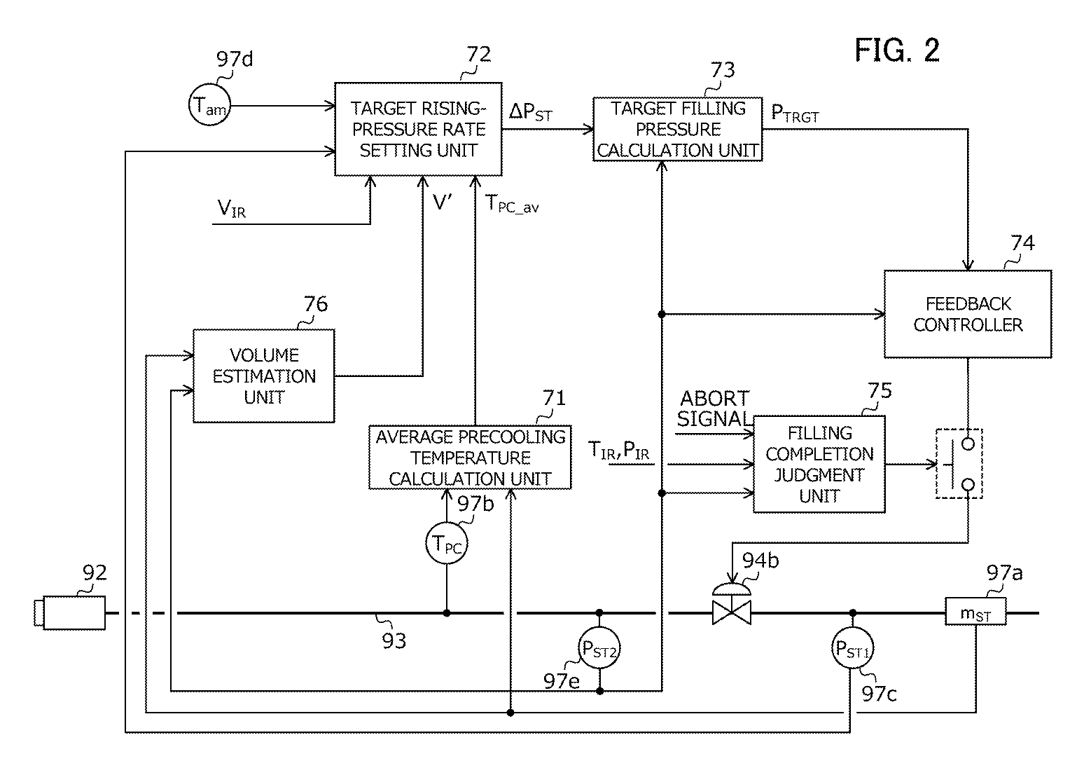

The station ECU 95 opens/closes the shut-off valve 94a and flowrate control valve 94b in accordance with the sequence explained by referencing FIGS. 2 to 6 later, after the filler nozzle 92 is connected to the receptacle provided in the vehicle V, to fill high-pressure hydrogen gas stored in the pressure accumulator 91 into the hydrogen tank 31 of the vehicle V.

A cooler 96 for cooling the hydrogen gas is provided in the station piping 93 between the flowrate control valve 94b and filler nozzle 92. By cooling the hydrogen gas at a position before filled into the hydrogen tank 31 by way of such a cooler 96, a temperature rise of the hydrogen gas in the hydrogen tank 31 is suppressed, and consequently, quick filling becomes possible.

Various sensors 97a, 97b, 97c, 97d, 97e are connected to the station ECU 95 for grasping the state of hydrogen gas at a position before being filled into the hydrogen tank 31.

A flow meter 97a is provided in the station piping 93 between the shut-off valve 94a and flowrate control valve 94b, and sends to the station ECU 95 a signal corresponding to the mass per unit time of hydrogen gas flowing in the station piping 93, i.e. mass flow rate. A station temperature sensor 97b is provided in the station piping 93 on a downstream side of the cooler 96, and sends a signal corresponding to the temperature of hydrogen gas inside the station piping 93 to the station ECU 95. An ambient temperature sensor 97d detects the temperature of ambient air, and sends a signal corresponding to the detection value to the station ECU 95. It should be noted that the ambient temperature detected by this ambient temperature sensor 97d may be able to be regarded as the temperature of hydrogen gas in the fuel tank of the vehicle V at the time of filling initiation.

A first station pressure sensor 97c is provided in the station piping 93 between the flowrate control valve 94b and the shut-off valve 94a, and sends a signal corresponding to the pressure of the hydrogen gas inside of the station piping 93 to the station ECU 95. A second station pressure sensor 97e is provided in the station piping 93 on a downstream side from the flowrate control valve 94b and cooler 96, and sends a signal corresponding to the pressure of hydrogen gas inside the station piping 93 to the station ECU 95.

An infrared communicator 98 for communicating with the vehicle V is provided to the filler nozzle 92. The infrared communicator 98 faces the infrared communicator 5 provided to the vehicle V when connecting the filler nozzle 92 to the receptacle 38, whereby sending/receiving of data signals via infrared light becomes possible between these communicators 98, 5.

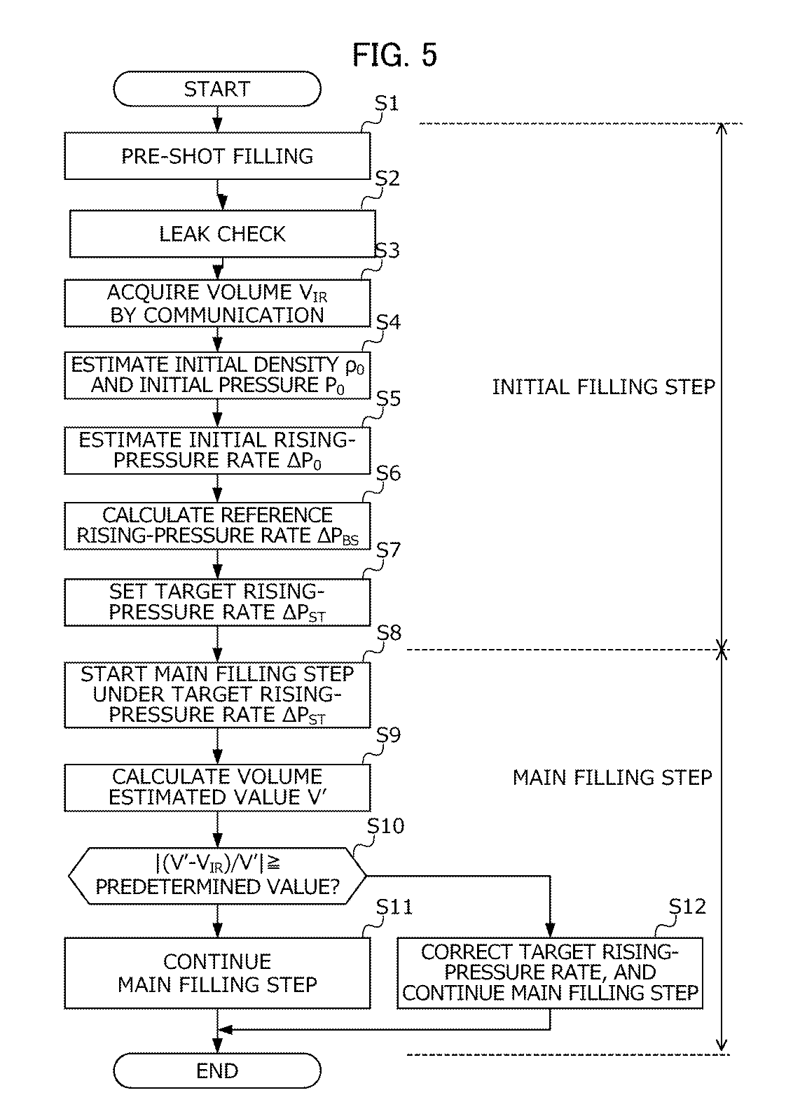

FIG. 2 is a functional block diagram showing the configuration of a control circuit for filling flowrate control by the station ECU 95. The gas filling step from starting until completing the filling of hydrogen gas in the hydrogen station is divided into an initial filling step of first filling hydrogen gas provisionally in order to obtain information related to the hydrogen tank of the vehicle; a main filling step of filling hydrogen gas under filling flowrate control by the station ECU 95 using the information obtained in the initial filling step (refer to flowchart of FIG. 5 described later, etc.). FIG. 2 illustrates modules 71 to 76 for realizing filling flowrate control in the main filling step in particular.

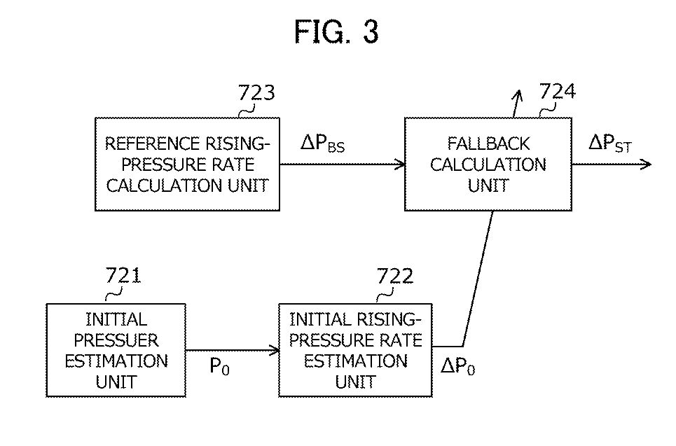

An average precooling temperature calculation unit 71 calculates an average precooling temperature T_{PC}_{_}_{AV}, which is the average temperature of hydrogen gas after passing through precooling, based on a detection value T_{PC} of the temperature sensor 97b and a detection value m_{ST} of the flowmeter 97a. The target rising-pressure rate setting unit 72 sets a target rising-pressure rate ΔP_{ST} corresponding to a target relating to the rising-pressure rate of the hydrogen tank during the main filling step. It should be noted that the specific sequence for setting the target rising-pressure rate ΔP_{ST} will be explained by referencing FIG. 3 later.

The target filling pressure calculation unit 73 calculates a target filling pressure P_{TRGT} corresponding to the target value for the filling pressure after a predetermined time, by using the target rising-pressure rate ΔP_{ST} set by the target rising-pressure rate setting unit 72, and the detection value P_{ST2} of the second station pressure sensor (hereinafter also referred to as “filling pressure”).

Based on a known feedback control law, a feedback controller 74 determines a command aperture of the flowrate control valve such that the filling pressure P_{ST2} becomes the target filling pressure P_{TRGT}, and inputs this to a drive device (not illustrated) of the flowrate control valve. The drive device adjusts the aperture of the flowrate control valve so as to realize this command aperture. In the main filling step, hydrogen gas is thereby filled so that the target rising-pressure rate ΔP_{ST} set by the target rising-pressure rate setting unit 72 is realized.

A filling completion judgment unit 75 judges whether the filling of hydrogen gas has completed, and in the case of having judged that filling has completed, sets the command aperture to 0 or closes the shut-off valve 94a in order to end the filling of hydrogen gas. With the filling completion judgment unit 75, the following such three filling completion conditions are defined, for example.

The first filling completion condition is the event of receiving an abort signal from the vehicle side. The filling completion judgment unit 75 sets the command aperture to 0 or closes the shut-off valve 94a in order to end the filling of hydrogen gas, in the case of having judged that this first filling completion condition was satisfied.

The second filling completion condition is the hydrogen SOC of the hydrogen tank during filling having exceeded a predetermined completion threshold. Herein, hydrogen SOC is a value arrived at by expressing the remaining amount of hydrogen gas stored in the hydrogen tank by a percentage relative to the maximum amount of hydrogen gas that can be stored in the hydrogen tank. The filling completion judgment unit 75 calculates the hydrogen SOC during filling by inputting the temperature transmitted value T_{IR} from the vehicle side and the filling pressure P_{ST2} into a known estimation formula, and in the case of this hydrogen SOC exceeding the above-mentioned completion threshold, sets the command aperture to 0 or closes the shut-off valve 94a in order to cause the filling of hydrogen gas to end.

The third filling completion condition is the filling pressure P_{ST2} having exceeding a predetermined completion threshold. The filling completion judgment unit 75 sets the command aperture to 0 or closes the shut-off valve 94a in order to cause the filling of hydrogen gas to end, in the case of the filling pressure P_{ST2} detected by the pressure sensor having exceeded the above-mentioned completion threshold.

The volume estimation unit 76 calculates an estimated value V′ for the volume of the hydrogen tank using information other than volume transmitted value V_{IR} sent from the vehicle side. More specifically, it calculates an estimated value V′ for the volume of the hydrogen tank according to Formula (1) noted below, using two different values obtained at the two of a first time to and second time tb from after starting filling until a predetermined time has elapsed under a fixed rising pressure rate. Formula (1) below is derived by combining the real gas equations established at each of the above first time and second time.

$${V}^{′} = \frac{R \cdot dm}{\frac{{P}_{b}}{{T}_{b} \cdot {Z}_{b} ( {P}_{b} )} - \frac{{P}_{a}}{{T}_{a} \cdot {Z}_{a} ( {P}_{a} )}} \qquad ( 1 )$$

In formula (1) above, “R” is the gas constant, and is a fixed value.

“dm” is a value of the filling amount of hydrogen gas between the aforementioned first time and second time, for example, and a value calculated by integrating the detection value of the mass flow meter 97a between the first time to second time is used.

“Tₐ” and “T_{b}” are values of the temperature of hydrogen gas in the hydrogen tank at the first time and second time, respectively. More specifically, for “Tₐ”, for example, the detection value Tₐₘ of the ambient temperature sensor at the first time is used. In addition, “T_{b}” is calculated by inputting the detection value of the ambient temperature sensor, detection value of the gas temperature sensor, etc. into a temperature prediction formula established in advance.

“Pₐ” and “P_{b}” are values of the pressure of hydrogen gas in the hydrogen tank at the first time and second time, respectively. More specifically, for example, the detection values P_{ST2} of the second station pressure sensor at the first time and second time are used for “Pₐ” and “P_{b}”, respectively. However, during the filling of hydrogen gas, since a pressure drop arises in the channel of hydrogen gas between the station and the vehicle, the pressure is higher on the station side than inside the hydrogen tank. Therefore, in the case of estimating “Pₐ” and “P_{b}” using the output of the pressure sensor on the station side as described above, it is preferable to temporarily stop the filling of hydrogen gas, or decrease the flowrate, at the times of estimating this, i.e. at the first time and second time.

In addition, “Zₐ(Pₐ)” and “Z_{b}(P_{b})” are values of the compressibility factor of hydrogen gas in the hydrogen tank at the first time and second time, respectively. More specifically, they are calculated by inputting the values “Pₐ” and “P_{b}” for pressure at each time, the values “Tₐ” and “T_{b}” for temperature at each time, etc. into the estimation formula for compressibility factor established in advance as a function of the pressure of hydrogen gas in the hydrogen tank.

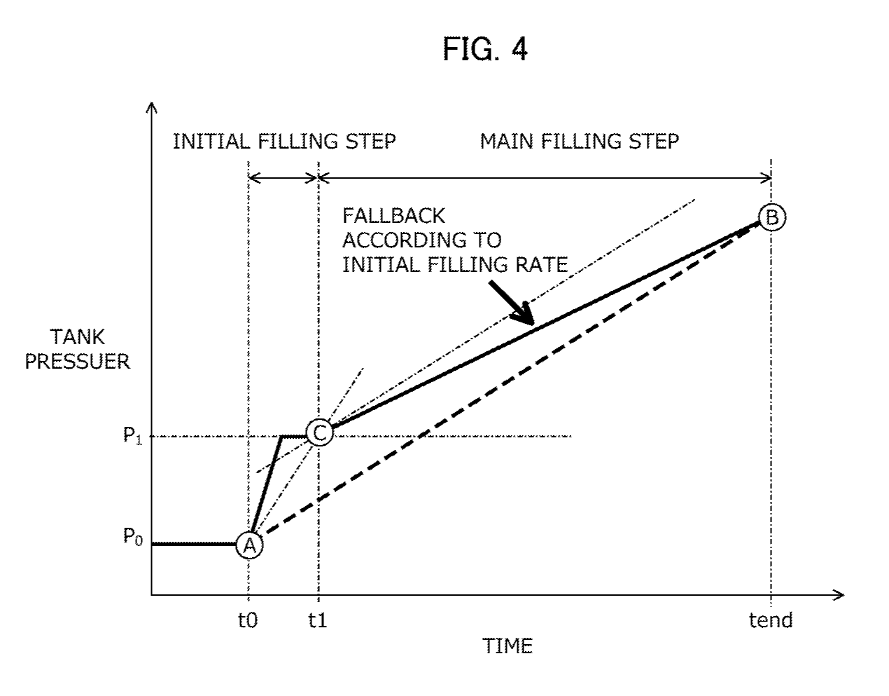

FIG. 3 is a view showing a specific algorithm of setting the target rising-pressure rate in the target rising-pressure rate setting unit 72. FIG. 4 is a view illustrating a sequence of setting the target rising-pressure rate.

An initial pressure estimation unit 721 estimates an initial pressure P₀, which is the pressure of the hydrogen tank when starting the initial filling step, in a time from after starting the initial filling step until starting the main filling step. More specifically, after executing pre-shot filling included in the initial filling step, and then estimating an initial density ρ₀, which is the density of the hydrogen tank during start of the initial filling step according to formula (2) below, using the pressure inside the station piing detected using the first station pressure sensor, the volume of the hydrogen tank, etc., the initial pressure estimation unit 721 estimates the initial pressure P₀ according to a known arithmetic expression using this initial density ρₒ and the initial temperature corresponding to the temperature of the hydrogen tank during start of the initial filling step. It should be noted that the temperature of the hydrogen tank during the start of the initial filling step is considered to be roughly equivalent to the outside air temperature; therefore, the temperature T_{amb} detected by the ambient temperature sensor is used as is in this initial temperature, for example.

$${ρ}_{0} = {ρ}_{1} - ( \frac{{V}_{PRE}}{V} ) ( {ρ}_{PRE} - {ρ}_{1} ) \qquad ( 2 )$$

In Formula (2) above, “V_{PRE}” is the volume of a storage segment temporarily rising in pressure during pre-shot filling (more specifically, segment within station piping from shut-off valve until flowrate control valve), and a value decided in advance is used. In addition, “ρ_{PRE}” is the density of gas enclosed within the above-mentioned storage segment immediately before starting pre-shot filling. This density ρ_{PRE} is calculated by using the pressure P_{ST1} within the storage segment detected using the first station pressure sensor immediately prior to pre-shot filling and temperature within the storage segment immediately prior to starting the pre-shot filling. It should be noted that the temperature within the storage segment immediately prior to starting this pre-shot filling may be directly acquired using a temperature sensor (not illustrated) or may be estimated using a known arithmetic expression.

In addition, in Formula (2) above, “ρ₁” is the density of gas being filled into the hydrogen tank after pre-shot filling. For this density pi, the pressure within the station piping detected using the first or second station pressure sensor immediately after the pre-shot filling and the temperature within the hydrogen tank immediately after the pre-shot filling are used. It should be noted that the temperature of the hydrogen tank immediately after this pre-shot filling can be estimated by a known arithmetic expression using the initial temperature To of the hydrogen tank, temperature within the storage segment immediately before starting the aforementioned pre-shot filling, etc., for example. In addition, “V” is the volume of the hydrogen tank, and the volume transmitted value V_{IR} sent from the vehicle side, or an estimated value V′ calculated by the aforementioned volume estimation unit 76 is used. In addition, Formula (2) above is derived based on the law of conservation of mass established before and after the pre-shot filling.

It should be noted that, in the case of the assumption in that the temperatures of the hydrogen tank before and after the pre-shot filling are almost the same being appropriate, Formula (3) below, which is similar to Formula (2) above, is established for the initial pressure P₀. Therefore, in the case of such an assumption being appropriate, a direct initial pressure P₀ may be calculated using Formula (3) below, without passing through the calculation of the initial density ρ₀ as mentioned above. It should be noted that, in Formula (3) below, “P_{PRE}” is the pressure within the above-mentioned storage segment immediately before starting the pre-shot filling, and the pressure P_{ST1} within the storage segment detected using the first station pressure sensor immediately before pre-shot filling is used. In addition, “P₁” is the pressure of the hydrogen tank after the pre-shot filling, and the pressure within the station piping detected using the first or second station pressure sensor immediately after the pre-shot filling is used. It should be noted that immediately after pre-shot filling, due to considering the pressure within the station piping to be roughly equivalent at the detection location of the first station pressure sensor and at the detection location of the second station pressure sensor, the above-mentioned pressure P₁ may employ the first station pressure sensor, or may employ the second station pressure sensor.

$${P}_{0} = {P}_{1} - ( \frac{{V}_{PRE}}{V} ) ( {P}_{PRE} - {P}_{1} ) \qquad ( 3 )$$

The initial rising-pressure rate estimation unit 722 estimates the initial rising-pressure rate ΔP₀, which is the rising-pressure rate of the hydrogen tank in the time from starting until completing the initial filling step, from when starting the initial filling step until starting the main filling step. More specifically, with the initial rising-pressure rate estimation unit 722 estimates the initial rising-pressure rate ΔP₀ by Formula (4) below, using the initial pressure P₀ estimated by the initial pressure estimation unit 721, the pressure P₁ of the hydrogen tank after pre-shot filling, and a time t_{PRE} required in the initial filling step (=t1−t0). This initial rising-pressure rate ΔP₀ corresponds to the slope of the one-dot dashed line A-C in the example of FIG. 4.

$$Δ {P}_{0} = ( \frac{{P}_{1} - {P}_{0}}{{t}_{PRE}} ) \qquad ( 4 )$$

The reference rising-pressure rate calculation unit 723 calculates a reference rising-pressure rate ΔP_{BS} that serves as a reference upon setting the target rising-pressure rate ΔP_{ST} for the main filling step. This reference rising-pressure rate is an ideal rising-pressure rate decided so that the temperature of the hydrogen tank prior to reaching complete filling does not exceed a predetermined upper limit and so as to achieve complete filling in as short a time as possible, in a case of assuming to start the main filling step under a fixed rising-pressure rate without executing the initial filling step. The reference rising-pressure rate calculation unit 723, when the reference point specified by the start time of filling and the initial pressure of the hydrogen tank at the start time, volume of the hydrogen tank, outside air temperature and hydrogen gas temperature are inputted, calculates the above-mentioned such ideal rising-pressure rate by searching a map (not illustrated) established in advance based on these parameters.

More specifically, the reference rising-pressure rate calculation unit 723 uses the reference point (arrow A in FIG. 4) specified by the start time of the initial filling step (time t0 in FIG. 4) and the initial pressure P₀ estimated by the initial pressure estimation unit 721 as an input parameter upon calculating the reference rising-pressure rate ΔP_{BS}. The reference rising-pressure rate ΔP_{BS} corresponding to the slope of the dotted line A-B in FIG. 4 is thereby calculated. In addition, the volume transmitted value V_{IR} sent from the vehicle side or the estimated value V′ calculated by the volume estimation unit 76 is used as the volume of the hydrogen tank serving as an input parameter used upon calculating the reference rising-pressure rate ΔP_{BS}, the ambient temperature T_{amb} detected by the ambient temperature sensor is used as the outside air temperature, and the average precooling temperature T_{PC}_{_}_{AV} calculated by the average precooling temperature calculation unit 71 is used as the hydrogen gas temperature.

The fallback calculation unit 724 sets a target rising-pressure rate ΔP_{ST} in the vicinity of the reference rising-pressure rate ΔP_{BS} by using the deviation between the reference rising-pressure rate ΔP_{BS} and the initial rising-pressure rate ΔP₀. More specifically, the fallback calculation unit 724 adopts the reference rising-pressure rate ΔP_{BS} as the target rising-pressure rate ΔP_{ST} as is (ΔP_{BS}=ΔP_{ST}), in the case of the initial rising-pressure rate being no more than the reference rising-pressure rate (ΔP₀≤ΔP_{BS}). In contrast, in the case of the initial rising-pressure rate being at least the reference rising-pressure rate (ΔP₀>ΔP_{BS}), the target rising-pressure rate ΔP_{ST} is set lower than the reference rising-pressure rate ΔP_{BS} in order to compensate for this deviation. More specifically, the fallback calculation unit 724 sets the target rising-pressure rate ΔP_{ST} to be lower than the reference rising-pressure rate ΔP_{BS} so that the completion predicted time of the main filling step becomes the same time as the completion predicted time t_{end} of a hypothetical main filling step in the case of executing the main filling step under the reference rising-pressure rate ΔP_{BS} without executing the initial filling step from the reference point A.

Next, a specific sequence for filling hydrogen gas in the above such hydrogen filling system will be explained. FIG. 5 is a flowchart showing the sequence for filling hydrogen gas in the hydrogen filling system. This processing starts in response to the filler nozzle of the hydrogen station being connected to the receptacle of the vehicle, and entering a state in which filling of hydrogen gas and communication are possible. As shown in FIG. 5, the gas filling step from starting until completing the filling of hydrogen gas is divided into the initial filling step (Steps S1 to S7) of filling hydrogen gas preliminarily, and the main filling step (Steps S8 and later) of filling hydrogen gas under a predetermined target rising-pressure rate.

In Step S1, the hydrogen station executes pre-shot filling. More specifically, while closing off the flowrate control valve provided in the station piping, the shut-off valve provided on the upstream side thereof is opened, and after the pressure rises within the station piping until the detection value of the first station pressure sensor provided on the upstream side from the flowrate control valve indicates a predetermined value, the shut-off valve is closed. Hydrogen gas of an amount according to the pressure is thereby filled into the storage segment inside the station piping from the flowrate control valve until the shut-off valve. Next, the flowrate control valve is opened while leaving the shut-off valve closed. Compressed hydrogen gas within the above-mentioned storage segment thereby flows immediately into the hydrogen tank, and the inside of the hydrogen tank and the inside of the station piping are equalized.

In Step S2, the hydrogen station temporarily stops filling, and executes a leak check for confirming the existence of filling leaks. In Step S3, the hydrogen station acquires the volume transmitted value V_{IR} from the vehicle using communication. In Step S4, the hydrogen station estimates the initial density P₀ and initial pressure P₀ of the hydrogen tank when starting the initial filling step in accordance with the sequence explained by referencing Formula (2) above, using the volume transmitted value V_{IR} acquired in Step S3. In Step S5, the hydrogen station estimates the initial rising-pressure rate ΔP₀ in the initial filling step in accordance with the sequence explained by referencing Formula (4) above, using the initial pressure P₀ estimated in Step S4.

In Step S6, the hydrogen station calculates the reference rising-pressure rate ΔP_{BS} in accordance with the sequence explained by referencing FIG. 3 with a state, in which the pressure of the hydrogen tank at the start time of pre-shot filling in Step S1 is the initial pressure P₀ estimated in Step S3, as the reference point. In Step S7, the hydrogen station sets the target rising-pressure rate ΔP_{ST} for the main filling step, in accordance with the sequence explaining by referencing FIG. 3, using the deviation between the reference rising-pressure rate ΔP_{BS} calculated in Step S6 and the initial rising-pressure rate ΔP₀ estimated in Step S5.

In Step S8, the hydrogen station starts the main filling step under the target rising-pressure rate ΔP_{ST} set in Step S7. In Step S9, the estimated value V′ for the volume of the hydrogen tank is calculated in accordance with the sequence explained by referencing Formula (1) above, using the time period immediately after starting the main filling step under the target rising-pressure rate ΔP_{ST}.

In Step S10, it is determined whether the relative error (|V′−V_{IR}|/V′) for the difference between the volume estimated value V′ acquired in Step S9 and the volume transmitted value V_{IR} acquired in Step S3 for use in the estimation of the initial pressure P₀, setting of the target rising-pressure rate ΔP_{ST}, etc. is at least a predetermined value that is positive. In the case of the determination in Step S10 being NO, it is verified that the volume transmitted value V_{IR} acquired using communication is correct, and then the main filling step is continued (refer to Step S11). In addition, in the case of the determination in Step S10 being YES, it is determined that the volume transmitted value V_{IR} acquired using communication is not correct, and thus the initial pressure P₀, initial rising-pressure rate ΔP₀ and reference rising-pressure rate ΔP_{BS} set using this, as well as the target rising-pressure rate ΔP_{ST} set using these, are not appropriate, the target rising-pressure rate ΔP_{ST} is corrected, and the main filling step is continued using this corrected target rising-pressure rate ΔP_{ST}′ (refer to Step S12). Herein, for the new target rising-pressure rate ΔP_{ST}′, an initial pressure, the initial rising-pressure rate and reference rising-pressure rate are calculated again using the volume estimated value V′ acquired in Step S9, and a value set again using these is used.

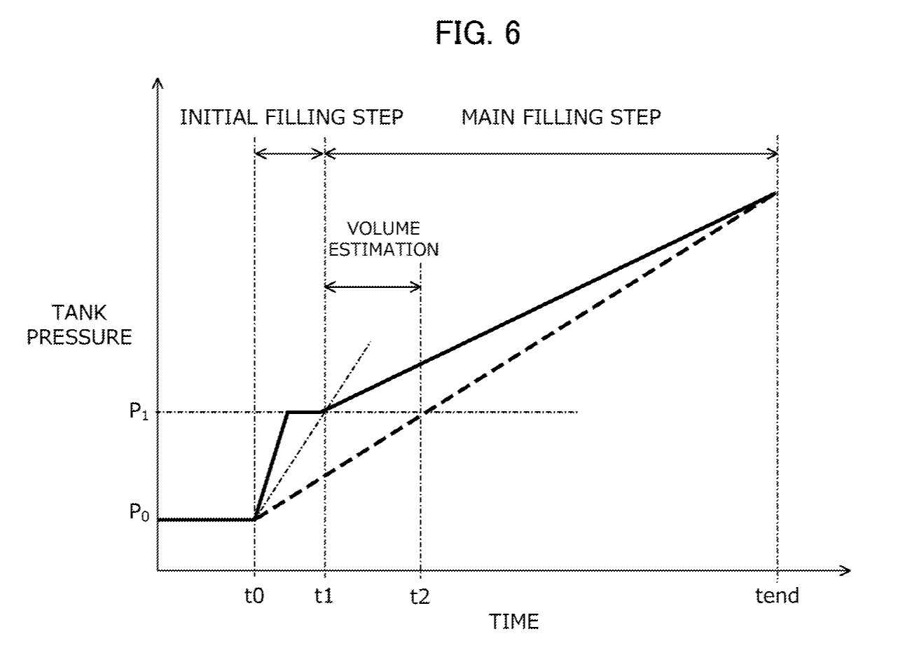

FIG. 6 is a time chart schematically showing the flow of filling of hydrogen gas realized according to the flowchart of FIG. 5. In FIG. 6, the solid line indicates the actual change in pressure within the tank, and the dotted line indicates the change of pressure within the tank in the case of filling hydrogen gas under the reference rising-pressure rate.

First, at time t0˜t1, pre-shot filling and leak check are executed (refer to Steps S1˜S2 in FIG. 5). The pressure within the hydrogen tank thereby rises from P₀ to P₁.

Next, at time t1, the volume transmitted value V_{IR} is acquired (refer to Step S3), and the initial pressure P₀ of the hydrogen tank at the moment starting the pre-shot filling is estimated using this (refer to Step S4). In addition, at time t1, the initial rising-pressure rate ΔP₀ (=(P₁−P₀)/(t1−t0)) in the initial filling step constituted by the pre-shot filling and leak check is estimated using the estimated initial pressure P₀, and the reference rising-pressure rate ΔP_{BS} with the reference points of time t0 and initial pressure P₀ is calculated (refer to Step S6). Furthermore, at time t1, the target rising-pressure rate ΔP_{ST} is set using the deviation between this initial rising-pressure rate ΔP₀ and reference rising-pressure rate ΔP_{BS}, and the main filling step is started under this target rising-pressure rate ΔP_{ST} (refer to Step S8). Herein, as shown in FIG. 6, in the case of the initial rising-pressure rate ΔP₀ being greater than the reference rising-pressure rate ΔP_{BS}, the target rising-pressure rate ΔP_{ST} is set to be lower than the reference rising-pressure rate ΔP_{BS}, so that the main filling step completes at the same time as the completion predicted time t_{end} in the case of starting the main filling step without executing the initial filling step under the reference rising-pressure rate ΔP_{BS}.

After starting the main filling step, at time t2, the volume estimated value V′ is calculated (refer to Step S9) using the time period in which hydrogen gas is being filled under the target rising-pressure rate ΔP_{ST} during times t1-t2, this volume estimated value V′ and the volume transmitted value V_{IR} acquired using communication previously are further compared, and finally it is verified whether the volume transmitted value V_{IR} acquired in order to set the target rising-pressure rate ΔP_{ST} is appropriate (refer to Step S10). Herein, after verifying that the volume transmitted value V_{IR} is appropriate, the main filling step is continued, and the main filling step ends at the completion predicted time t_{end}.

### Second Embodiment

Next a second embodiment of the present invention will be explained while referencing the drawings. It should be noted that, in the explanation of the present embodiment below, illustrations and explanations thereof will be omitted for points in common with the first embodiment. With the hydrogen filling system of the first embodiment, a case is explained of being able to acquire the volume transmitted value V_{IR} of the hydrogen tank on the hydrogen station side by employing communication established between the vehicle and hydrogen station (refer to Step S3 in FIG. 5). In contrast, with the hydrogen filling station of the present embodiment, a case will be explained of not being able to acquire the volume transmitted value V_{IR} of the hydrogen tank on the hydrogen station side for any reason.

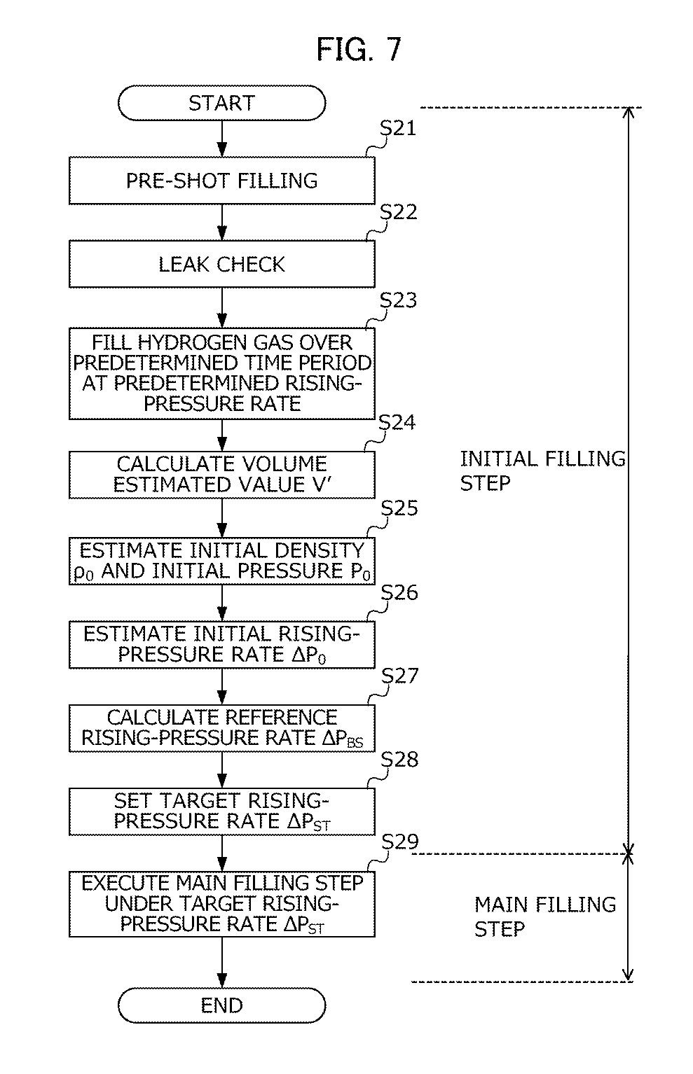

FIG. 7 is a flowchart showing a sequence for filling hydrogen gas in the hydrogen filling system according to the present embodiment. It starts in response to the filler nozzle of the hydrogen station being connected to the receptacle of the vehicle, and entering a state in which filling of hydrogen gas and communication are possible. As shown in FIG. 7, the gas filling step from starting until completing the filling of hydrogen gas is divided into the initial filling step (Steps S21 to S28) of preliminarily filling hydrogen gas, and the main filling step (Steps S29 and after) of filling hydrogen gas under a predetermined target rising-pressure rate.

In Steps S21 and S22, the hydrogen station executes pre-shot filling and leak check, similarly to Steps S1 and S2 in FIG. 5. In Step S23, the hydrogen station fills hydrogen gas over a predetermined time period at a fixed rising-pressure rate decided in advance, in order to estimate the volume of the hydrogen tank. It should be noted that, at this moment, since the hydrogen station cannot grasp the volume of the hydrogen tank, the target rising-pressure rate is set to the lowest value among those assumed.

In Step S24, the hydrogen station calculates the volume estimated value V′ of the hydrogen tank in accordance with the sequence explained by referencing Formula (1) above, using the time period in which hydrogen gas is being filled over the predetermined time period under the predetermined rising-pressure rate in Step S23.

In Step S25, the hydrogen station estimates the initial density P₀ and initial pressure P₀ of the hydrogen tank during the start of the initial filling step in accordance with the sequence explained by referencing Formula (2) above, using the volume estimated value V′. In Step S26, the hydrogen station estimates the initial rising-pressure rate ΔP₀ in the initial filling step, in accordance with the sequence explained by referencing Formula (4) above, using the initial pressure P₀ estimated in Step S25.

In Step S27, the hydrogen station calculates the reference rising-pressure rate ΔP_{BS} in accordance with the sequence explained by referencing FIG. 3 with a state, in which the pressure of the hydrogen tank at the start time of pre-shot filling in Step S1 is the initial pressure P₀ estimated in Step S25, as the reference point. In Step S28, the hydrogen station sets the target rising-pressure rate ΔP_{ST} for the main filling step, in accordance with the sequence explained by referencing FIG. 3, by using the deviation between the reference rising-pressure rate ΔP_{BS} calculated in Step S27 and the initial rising-pressure rate ΔP₀ estimated in Step S26. In Step S29, the hydrogen station executes the main filling step under the target rising-pressure rate ΔP_{ST} set in Step S28.

Although embodiments of the present invention are explained above, the present invention is not to be limited thereto. The detailed configurations may be modified as appropriate within a scope of the spirit of the present invention.

### EXPLANATION OF REFERENCE NUMERALS

S hydrogen filling system

V fuel cell vehicle (moving body)

31 hydrogen tank (tank)

39 vehicle piping (piping)

9 hydrogen station

91 pressure accumulator (supply source)

93 station piping (piping)

94b flowrate control valve (on-off valve)

97c first station pressure sensor (pressure sensor)

1. A gas filling method of a moving body that connects a supply source of compressed gas with a tank equipped to the moving body by way of piping, and fills gas into the tank, the method comprising:
a gas filling step from after initiating until completing filling of gas which is divided into an initial filling step of filling gas in order to obtain information related to the tank; and a main filling step of filling gas so that a target rising-pressure rate decided using the information obtained while executing the initial filling step is realized,
an initial rising-pressure rate estimation step of estimating an initial pressure of the tank during start of the initial filling step and an initial rising-pressure rate of the tank in the initial filling step;
a reference rising-pressure rate calculation step of calculating a reference rising-pressure rate of the tank in a case with a state in which the pressure of the tank is the initial pressure as a reference point, and assuming to start the main filling step from the reference point without executing the initial filling step; and
a target rising-pressure rate setting step of setting the target rising-pressure rate for the main filling step using a deviation between the initial rising-pressure rate and the reference rising-pressure rate.

2. The gas filling method according to claim 1, wherein the target rising-pressure rate is set to lower than the reference rising-pressure rate in the target rising-pressure rate setting step, in a case of the initial rising-pressure rate being higher than the reference rising-pressure rate.

3. The gas filling method according to claim 1, wherein an on-off valve, and a pressure sensor for detecting pressure on an upstream side from the on-off valve are provided in the piping,
wherein, in the initial filling step, after raising the pressure within a predetermined storage segment in the piping on an upstream side from the on-off valve in a state closing the on-off valve, the on-off valve is opened, and pre-shot filling is performed to fill compressed gas within the storage segment into the tank, and
wherein the initial pressure and the initial rising-pressure rate are estimated in the initial rising-pressure rate estimation step, based on the pressure within the piping detected using the pressure sensor after executing the pre-shot filling, the volume of the storage segment, and the volume of the tank.

4. The gas filling method according to claim 3, wherein the initial pressure is estimated based on the pressure within the piping detected using the pressure sensor after executing the pre-shot filling, the volume of the storage segment, and the volume of the tank, and the initial rising-pressure rate is estimated based on the initial pressure thus estimated, the pressure within the piping detected using the pressure sensor after executing the pre-shot filling, and a time required in the pre-shot filling, in the initial rising-pressure rate estimation step.

5. The gas filling method according to claim 1, further comprising a volume estimation step of acquiring an amount of gas filled into the tank during a predetermined time period under a fixed rising-pressure rate, and estimating the volume of the tank using the amount of gas acquired.

6. The gas filling method according to claim 5, wherein the volume of the tank is acquired using communication between the supply source and the moving body, and the initial pressure and the initial rising-pressure rate are estimated using the volume thus acquired, in the initial rising-pressure rate estimation step,
wherein the initial rising-pressure rate estimation step, the reference rising-pressure rate calculation step and the target rising-pressure rate setting step are executed up until starting the main filling step, and
wherein the volume estimation step estimates the volume of the tank using a time period immediately after starting the main filling step under the target rising-pressure rate set in the target rising-pressure rate setting step.

7. The gas filling method according to claim 6, further comprising a tank volume verification step of comparing between the volume of the tank acquired using communication in order to estimate the initial pressure and the initial rising-pressure rate in the initial rising-pressure rate estimation step, and the volume of the tank estimated in the volume estimation step.

8. The gas filling method according to claim 7, wherein, in a case of relative error of a difference between the volume acquired using the communication and the volume estimated in the volume estimation step being at least a predetermined value in the tank volume verification step, the target rising-pressure rate set in the target rising-pressure rate setting step is corrected, and the main filling step is continued using a corrected target rising-pressure rate.

9. The gas filling method according to claim 5,
wherein a volume of the tank is estimated in the volume estimation step using a time period for which gas is filled at a fixed rising-pressure rate determined in advance in the initial filling step, and
wherein the initial pressure and the initial rising-pressure rate are estimated in the initial rising-pressure rate estimation step using the volume of the tank estimated in the volume estimation step.

10. The gas filling method according to claim 1, wherein the target rising-pressure rate is set in the target rising-pressure rate setting step so that a completion predicted time of the main filling step becomes the same time as a completion predicted time of the main filling step in a case of executing the main filling step under the reference rising-pressure rate from the reference point without executing the initial filling step.

11. The gas filling method according to claim 2, wherein an on-off valve, and a pressure sensor for detecting pressure on an upstream side from the on-off valve are provided in the piping,
wherein, in the initial filling step, after raising the pressure within a predetermined storage segment in the piping on an upstream side from the on-off valve in a state closing the on-off valve, the on-off valve is opened, and pre-shot filling is performed to fill compressed gas within the storage segment into the tank, and
wherein the initial pressure and the initial rising-pressure rate are estimated in the initial rising-pressure rate estimation step, based on the pressure within the piping detected using the pressure sensor after executing the pre-shot filling, the volume of the storage segment, and the volume of the tank.

12. The gas filling method according to claim 11, wherein the initial pressure is estimated based on the pressure within the piping detected using the pressure sensor after executing the pre-shot filling, the volume of the storage segment, and the volume of the tank, and the initial rising-pressure rate is estimated based on the initial pressure thus estimated, the pressure within the piping detected using the pressure sensor after executing the pre-shot filling, and a time required in the pre-shot filling, in the initial rising-pressure rate estimation step.

13. The gas filling method according to claim 2, further comprising a volume estimation step of acquiring an amount of gas filled into the tank during a predetermined time period under a fixed rising-pressure rate, and estimating the volume of the tank using the amount of gas acquired.

14. The gas filling method according to claim 13, wherein the volume of the tank is acquired using communication between the supply source and the moving body, and the initial pressure and the initial rising-pressure rate are estimated using the volume thus acquired, in the initial rising-pressure rate estimation step,
wherein the initial rising-pressure rate estimation step, the reference rising-pressure rate calculation step and the target rising-pressure rate setting step are executed up until starting the main filling step, and
wherein the volume estimation step estimates the volume of the tank using a time period immediately after starting the main filling step under the target rising-pressure rate set in the target rising-pressure rate setting step.

15. The gas filling method according to claim 14, further comprising a tank volume verification step of comparing between the volume of the tank acquired using communication in order to estimate the initial pressure and the initial rising-pressure rate in the initial rising-pressure rate estimation step, and the volume of the tank estimated in the volume estimation step.

16. The gas filling method according to claim 15, wherein, in a case of relative error of a difference between the volume acquired using the communication and the volume estimated in the volume estimation step being at least a predetermined value in the tank volume verification step, the target rising-pressure rate set in the target rising-pressure rate setting step is corrected, and the main filling step is continued using a corrected target rising-pressure rate.

17. The gas filling method according to claim 13,
wherein a volume of the tank is estimated in the volume estimation step using a time period for which gas is filled at a fixed rising-pressure rate determined in advance in the initial filling step, and
wherein the initial pressure and the initial rising-pressure rate are estimated in the initial rising-pressure rate estimation step using the volume of the tank estimated in the volume estimation step.

18. The gas filling method according to claim 2, wherein the target rising-pressure rate is set in the target rising-pressure rate setting step so that a completion predicted time of the main filling step becomes the same time as a completion predicted time of the main filling step in a case of executing the main filling step under the reference rising-pressure rate from the reference point without executing the initial filling step.

19. The gas filling method according to claim 3, wherein the target rising-pressure rate is set in the target rising-pressure rate setting step so that a completion predicted time of the main filling step becomes the same time as a completion predicted time of the main filling step in a case of executing the main filling step under the reference rising-pressure rate from the reference point without executing the initial filling step.

20. The gas filling method according to claim 4, wherein the target rising-pressure rate is set in the target rising-pressure rate setting step so that a completion predicted time of the main filling step becomes the same time as a completion predicted time of the main filling step in a case of executing the main filling step under the reference rising-pressure rate from the reference point without executing the initial filling step.
